(19) United States
(12) Patent Application Publication
(10) Pub. No.: US 2015/0111439 A1
(43) Pub. Date: Apr. 23, 2015

(54) JOINT TERMINAL

(71) Applicant: YAZAKI CORPORATION, Tokyo (JP)

(72) Inventor: Yoshifumi SHINMI, Makinohara-shi (JP)

(21) Appl. No.: 14/583,299

(22) Filed: Dec. 26, 2014

Related U.S. Application Data
(63) Continuation of application No. PCT/JP2013/066311, filed on Jun. 13, 2013.

(30) Foreign Application Priority Data
Jul. 4, 2012 (JP) 2012-150264

(51) Int. Cl. H01R 13/04; H01R 13/11

(52) U.S. Cl. CPC H01R 13/04; H01R 13/11
USPC 439/796

(57) ABSTRACT

A joint terminal includes: a main body portion formed into a rectangular-cylindrical shape; a male contact portion protruding from a first side wall portion of the main body portion; a female contact portion which is located inside the main body portion and includes a plate spring-shaped spring portion having an indent formed thereon, in which this indent is formed on an end portion, and in which a portion having the indent formed thereon is raised higher than a surrounding portion; and a slit provided at a second side wall portion of the main body portion.

### CROSS REFERENCE TO RELATED APPLICATIONS

This application is a Continuation of PCT Application No. PCT/JP2013/066311, filed on Jun. 13, 2013, and claims the priority of Japanese Patent Application No. 2012-150264, filed on Jul. 4, 2012, the content of both of which is incorporated herein by reference.

### TECHNICAL FIELD

The present invention relates to a joint terminal, and in particular, a joint terminal manufactured by machining a sheet material and used by being mounted at one end of an electric wire.

### BACKGROUND ART

Conventionally, there is a known joint terminal which is mounted at each end portion of plural electric wires, and which ensures electrical connectivity between these electric wires by the connection of the joint terminals with each other (see, for example, Patent Literature 1).

The conventional joint terminal described above includes a rectangular-cylindrical main body portion, a male contact portion (tongue-shaped engaging piece), and a female contact portion (energizing portion, locking piece). The male contact portion protrudes from the main body portion, and the female contact portion exists within the main body portion.

Then, the male contact portion of one joint terminal is engaged with the female contact portion in the main body portion of the other joint terminal, and the respective joint terminals are integrated with each other, thereby being electrically conducted.

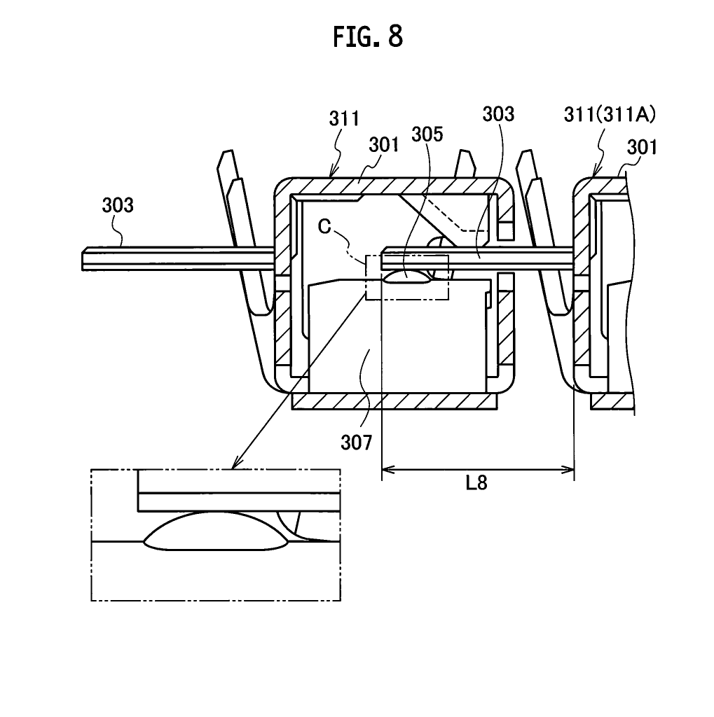

Furthermore, as illustrated in FIG. 8, conventionally, there is proposed a joint terminal 311 including: a main body portion 301 formed into a rectangular-cylindrical shape; a plate-like male contact portion 303 protruding toward a lateral direction from a side wall portion on one side of the main body portion 301 in the lateral direction; and a female contact portion 309 which is located inside the main body portion 301 and includes a plate spring-shaped spring portion 307 having an indent 305 formed thereon. Note that, in FIG. 8, the portion C is enlarged and illustrated at the lower left portion in the drawing.

Note that the joint terminal 311 is configured such that, by relatively moving the joint terminal 311 in a direction perpendicular to the paper surface of FIG. 8 with respect to a joint-terminal accommodating housing (not illustrated in FIG. 8), the joint terminal 311 is accommodated in an accommodating hole of the joint-terminal accommodating housing, or is taken out from the accommodating hole.

### CITATION LIST

### Patent Literature

Patent Literature 1: Japanese Patent Laid-Open Publication No. 2007-87810

### SUMMARY OF INVENTION

### Technical Problem

Incidentally, the joint terminal 311 illustrated in FIG. 8 has a problem in which the indent 305 (the indent in contact with the male contact portion 303 of the other joint terminal 311A) is formed at a laterally central portion of the spring portion 307, and thus the amount of protrusion (length of protrusion; the dimension L8 illustrated in FIG. 8) of the male contact portion 303 of joint terminal 311A has to be increased.

The present invention has been made in view of the problem described above, and an object of the present invention is to provide a joint terminal manufactured by forming a sheet-like metal base material into a predetermined shape and subjecting the base material formed into the predetermined shape to bending processing, the joint terminal being capable of reducing a value of the protruding length of a male contact portion protruding from an end portion on one side in the lateral direction, as compared with the conventional one.

### Solution to Problem

The present invention provides a joint terminal manufactured by forming a sheet-like metal base material into a predetermined shape and subjecting the base material formed into the predetermined shape to bending processing, including: a main body portion formed into a rectangular-cylindrical shape; a male contact portion protruding from a first side wall portion that is a side wall portion on one side of the main body portion in a lateral direction; a female contact portion which is located inside the main body portion and includes a plate spring-shaped spring portion having an indent formed thereon, in which this indent is formed so as to extend from an end of the spring portion on the other side in the lateral direction to a portion in the vicinity thereof, and in which a portion having the indent formed thereon is raised higher than a surrounding portion at an end of the spring portion on the other side in the lateral direction; and a slit provided at a second side wall portion that is a side wall portion on the other side of the main body portion in the lateral direction.

According to the joint terminal of the present invention, it is preferable that the indent is formed in a spherical crown shape, and the peak of the spherical crown exists at the spring portion.

According to the joint terminal of the present invention, it is preferable that the indent protrudes by a height sufficient to avoid interference of a top end of the male contact portion of another joint terminal with the spring portion, even if the spring portion deforms due to torsional moment generated in the spring portion at the time when the male contact portion of the another joint terminal is engaged with the female contact portion.

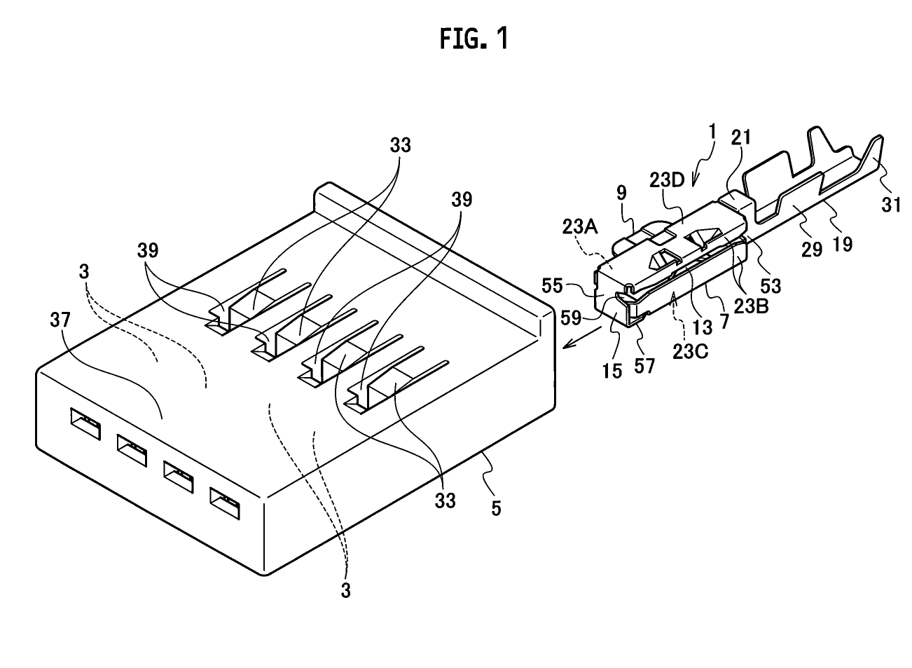

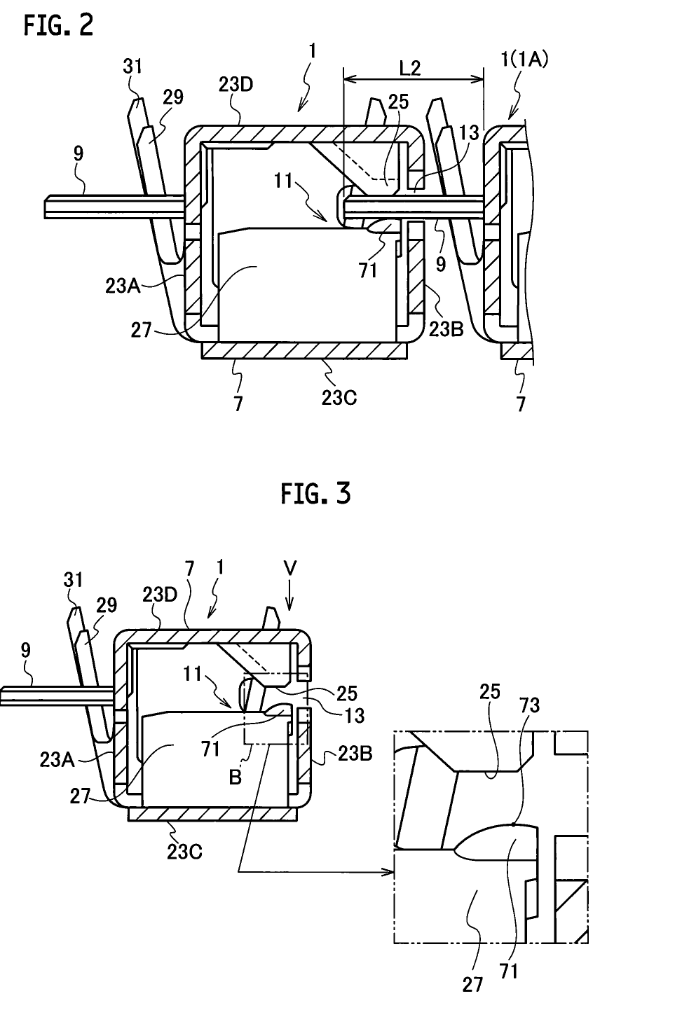

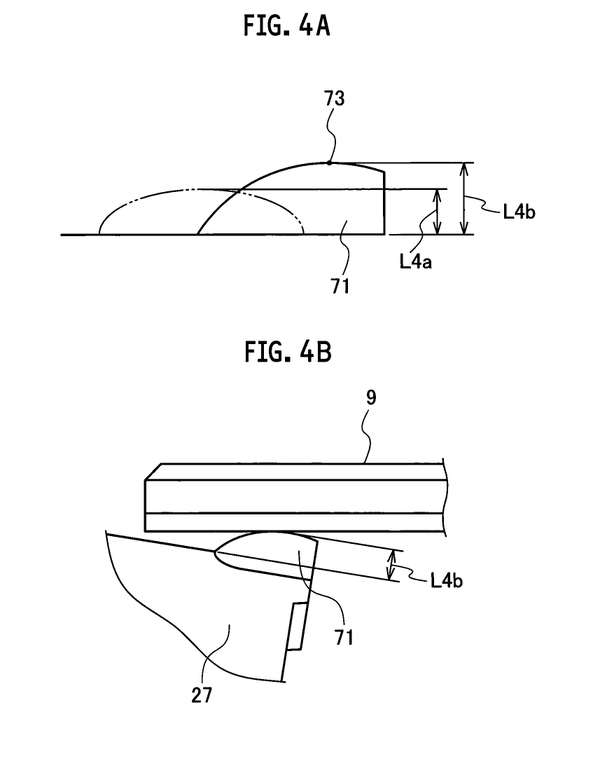

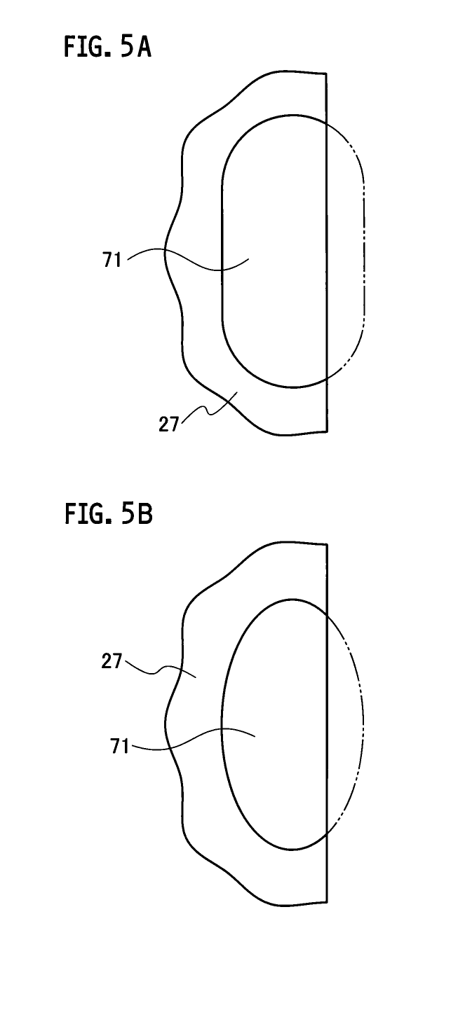

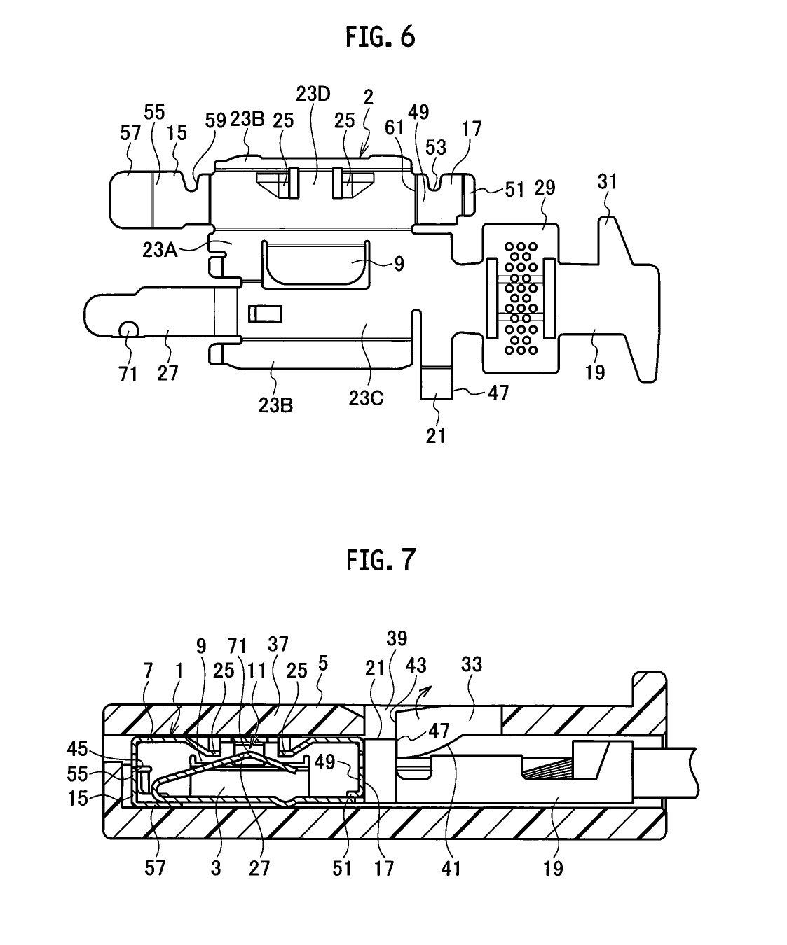

### BRIEF DESCRIPTION OF DRAWINGS

[FIG. 1] FIG. 1 is a perspective view illustrating a schematic configuration of a joint terminal according to an embodiment of the present invention and a housing that accommodates this joint terminal.

[FIG. 2] FIG. 2 is a cross-sectional view illustrating a cross section of joint terminals according to the embodiment of the present invention taken along a plane (plane perpendicular to a front-rear direction) extending in a vertical direction and a lateral direction, and illustrating a state where the joint terminals are engaged with each other.

[FIG. 3] FIG. 3 is a cross-sectional view illustrating a cross section of the joint terminal according to the embodiment of the present invention, taken along a plane extending in a vertical direction and a lateral direction.

[FIG. 4A] FIG. 4A is a diagram illustrating a protruding height of an indent.

[FIG. 4B] FIG. 4B is a diagram illustrating a relationship in terms of relative positions between a male contact portion and an indent in a state where a spring portion elastically deforms.

[FIG. 5A] FIG. 5A is a diagram illustrating a shape of an indent according to modification examples, obtained by cutting out part of an oval when viewed in the direction V in FIG. 3.

[FIG. 5B] FIG. 5B is a diagram illustrating a shape of an indent according to modification examples, obtained by cutting out part of an ellipse when viewed in the direction V in FIG. 3.

[FIG. 6] FIG. 6 is an expanded view illustrating a joint terminal according to an embodiment of the present invention.

[FIG. 7] FIG. 7 is a cross-sectional view illustrating a joint terminal according to an embodiment of the present invention in a state where the joint terminal is placed in a housing.

[FIG. 8] FIG. 8 is a diagram illustrating conventional joint terminals in a state where they are engaged with each other, and corresponding to FIG. 2.

### DESCRIPTION OF EMBODIMENTS

Hereinafter, a joint terminal according to the present invention will be described with reference to the drawings.

A joint terminal 1 (connector terminal) according to an embodiment of the present invention is used by being mounted at an end portion of an electric wire. Then, each of the joint terminals 1 mounted to plural electric wires (not illustrated) is caused to be accommodated in a joint-terminal accommodating housing 5 (housing) having plural accommodating holes 3 (each of the joint terminals 1 is inserted into and is accommodated in each of the accommodating holes 3), whereby the electric wires are connected (electrically conducted) with each other through each of the joint terminals 1 (see, for example, FIG. 2 and FIG. 7).

Furthermore, the joint terminal 1 is manufactured by forming a sheet-like (for example, a flat sheet-like) metal base material into a predetermined shape (see FIG. 6), and subjecting a base material 2 formed into the predetermined shape to suitable bending processing. Note that the base material 2 after the bending processing has a flat shape, and has a predetermined shape when viewed in a thickness direction thereof.

Here, for convenience of explanation, a longitudinal direction of the joint terminal 1 is set to a front-rear direction (a direction in which the joint terminal 1 is inserted into or removed from the housing 5); one direction perpendicular to the longitudinal direction is set to a lateral direction; and a direction perpendicular to the front-rear direction and the lateral direction is set to a vertical direction.

As illustrated, for example, in FIG. 1, the joint terminal 1 has the outer shape with a substantially quadrangular prism shape. The joint terminal 1 is accommodated in each of the accommodating holes 3 having a quadrangular prism shape of the housing 5, thereby being integrally placed in the housing 5.

As illustrated in FIG. 1, by moving the joint terminal 1 forward from a state where the housing 5 (housing being spaced apart from the joint terminal 1 and keeping an appropriate position at a predetermined appropriate location) is located in front of the joint terminal 1 in the longitudinal direction, the joint terminal 1 is caused to be accommodated in each of the accommodating holes 3 (accommodating holes arranged in the lateral direction) of the housing 5, thereby being set integrally in the housing 5.

In one housing 5, plural joint terminals 1 are simultaneously placed by being arranged in the lateral direction. These joint terminals 1 mounted as described above are configured such that the joint terminals 1 adjacent to each other are brought into contact with each other and are electrically conducted with each other.

The joint terminal 1 includes a main body portion 7, a male contact portion 9 (male terminal portion), a female contact portion 11 (female terminal portion), a slit 13 (side slit), a front wall portion 15, a rear wall portion 17, a wire connection portion 19, and a lance engaging portion 21.

The main body portion 7 is formed into a rectangular-cylindrical shape. The rectangular-cylindrical main body portion 7 includes four side wall portions each having a rectangular flat shape (a first side wall portion 23A, a second side wall portion 23B, a third side wall portion 23C, and a fourth side wall portion 23D). The first side wall portion 23A is located on one side of the main body portion 7 in the lateral direction. The second side wall portion 23B faces the first side wall portion 23A, and is located on the other side of the main body portion 7 in the lateral direction. The third side wall portion 23C is located on one side of the main body portion 7 in the vertical direction. The fourth side wall portion 23D faces the third side wall portion 23C, and is located on the other side of the main body portion 7 in the vertical direction.

The male contact portion 9 is formed into a plate shape, and protrudes toward one side in the lateral direction from the first side wall portion 23A that is a side wall portion on one side of the main body portion 7 in the lateral direction.

The male contact portion 9 is formed into, for example, a flat plate shape, and the thickness direction thereof is set to the vertical direction. In addition, the male contact portion 9 is located in the middle of the main body portion 7 in the vertical direction, and is located in the middle of the main body portion 7 in the front-rear direction.

The female contact portion 11 is provided within the main body portion 7. As illustrated in FIG. 2, FIG. 3, FIG. 7 and the like, the female contact portion 11 includes a contact portion 25 and a spring portion 27. Note that, in FIG. 3, the portion B is enlarged and illustrated at the lower right portion in the drawing. The contact portion 25 is formed so as to protrude inward from the fourth side wall portion 23D of the main body portion 7. The spring portion 27 is formed so as to protrude inward from the third side wall portion 23C of the main body portion 7. The contact portion 25 is located on the other side in the vertical direction, and the spring portion 27 is located on one side in the vertical direction.

Furthermore, the plate spring-shaped spring portion 27 of the female contact portion 11 has an indent 71 (convex portion) formed thereon. The indent 71 is formed so as to extend from an end of the spring portion 27 on the other side in the lateral direction, to a portion in the vicinity thereof. Moreover, at the end (right end in FIG. 2 and FIG. 3) of the spring portion 27 on the other side in the lateral direction, a portion having the indent 71 formed thereon is raised higher than the surrounding portion (raised upward in FIG. 2 and FIG. 3).

The indent 71 is formed so as to have a convex shape toward the side of the contact portion 25 (the other side in the vertical direction; upper side in FIG. 2 and FIG. 3) at a part of a flat plate-shaped plate spring (a part of the top portion of a mountain shape; see FIG. 7). When the plate spring (a plate spring whose width direction extends in the lateral direction and whose thickness direction extends substantially in the vertical direction) of the spring portion 27 is viewed in the thickness direction thereof (the vertical direction), the indent 71 overlaps an end (end portion; end surface) of the plate spring in the lateral direction. Namely, for example, in the case where the indent 71 is formed at the central portion of the plate spring, the entire periphery of the indent formed into a circular shape is surrounded by a flat plate-shaped portion (portion of the plate spring other than the indent) that does not have a convex shape. However, since the indent 71 overlaps the end of the plate spring in the lateral direction, the indent 71 has a shape in which a part thereof is removed (see FIG. 3, FIG. 6 and the like).

The slit 13 is provided at the second side wall portion 23B that is the side wall portion on the other side of the main body portion 7 in the lateral direction.

As illustrated, for example, in FIG. 1, the slit 13 is located in the middle portion of the main body portion 7 in the vertical direction, and penetrates the main body portion 7 (second side wall portion 23B) in the front-rear direction. With the slit 13 being formed, the second side wall portion 23B is divided into two portions.

With the slit 13 being provided, the main body portion 7 does not have a cylindrical shape in a strict sense, but in this specification, it is assumed that the main body portion 7 has a cylindrical shape for convenience of explanation. Furthermore, as to a value of the width of the slit 13 (dimension in the vertical direction), the slit 13 has portions formed into a tapered shape extending from both end portions in the front-rear direction to the vicinity of these portions, and the width thereof becomes larger as approaching each of the end portions. Moreover, the value of the width of the slit 13 in the middle portion in the front-rear direction is larger than the value of the thickness (dimension in the vertical direction) of the male contact portion 9, and in the vertical direction, the slit 13 is located at the same position as the male contact portion 9 (as to the vertical direction, the position of the center of the slit 13 in the vertical direction coincides with the position of the center of the male contact portion 9 in the vertical direction).

Then, by simultaneously placing plural joint terminals 1 in one housing 5 so as to be arranged in the lateral direction, joint terminals 1 adjacent to each other are configured such that the male contact portion 9 of one joint terminal 1 is engaged with the female contact portion 11 of the other joint terminal 1, and the joint terminals 1 adjacent to each other are electrically conducted, as illustrated, for example, in FIG. 2 (in which illustration of the housing 5 is omitted).

Note that the male contact portion 9 is configured to pass through a cutout (not illustrated) formed on a wall portion between accommodating holes 3, enter the inside of the adjacent accommodating hole 3, then pass through the slit 13 to thereby enter the main body portion 7 of a joint terminal 1 accommodated in the adjacent accommodating hole 3, and engage with the female contact portion 11.

More specifically, the male contact portion 9 of one joint terminal is sandwiched by the contact portion 25 of the female contact portion 11 of the other joint terminal 1 and the sheet-like spring portion 27, with an energizing force obtained by the spring portion 27 (the spring portion 27 illustrated in FIG. 7 elastically deforms downward to be lower than the position illustrated in FIG. 7 to thereby squeeze the plate-like male contact portion 9 by the contact portion 25 and the spring portion 27), whereby the male contact portion 9 of one joint terminal 1 reliably engages with the female contact portion 11 of the other joint terminal 1.

Note that, when plural joint terminals 1 are simultaneously placed in one housing 5 so as to be arranged in the lateral direction, the male contact portion 9 of one joint terminal 1 existing at one end in the lateral direction is not engaged with any female contact portion 11, since there exists no adjacent joint terminal 1.

Furthermore, when plural joint terminals 1 are simultaneously placed in one housing 5 so as to be arranged in the lateral direction, the female contact portion 11 of one joint terminal 1 existing at the other end in the lateral direction is not engaged with any male contact portion 9, since there exists no adjacent joint terminal 1.

As illustrated in FIG. 7 and the like, the rear wall portion 17 is provided at an opening portion located at the rear side of the cylindrical main body portion 7 so as to close this opening portion, in order to reinforce the cylindrical main body portion 7 and prevent the deformation of the main body portion 7. With this configuration, the rigidity of the cylindrical main body portion 7 is increased, whereby it is possible to prevent the deformation of the main body portion 7.

As illustrated in FIG. 1 and the like, the wire connection portion 19 protrudes rearward from the main body portion 7 at the rear side of the cylindrical main body portion 7. The wire connection portion 19 includes a conductor holding portion 29 that holds a bare conductor (a conductor of the electric wire) from which coating is removed, and a coating holding portion 31 that holds a coating portion of the electric wire. The conductor holding portion 29 and the coating holding portion 31 are swaged, thereby holding the electric wire (the joint terminal 1 is constituted so as to be integrally mounted at the end portion of the electric wire).

The lance engaging portion 21 protrudes rearward from the main body portion 7 at the rear side of the cylindrical main body portion 7, and a portion of the lance engaging portion 21, with which the lance 33 of the housing 5 is engaged when the joint terminal 1 is placed in the housing 5, becomes angular (formed into an edge 47 as illustrated in FIG. 7 and the like; in a shape that does not have any round shape R or any chamfer formed thereon).

Note that, in the joint terminal 1, the rear wall portion 17, the lance engaging portion 21, the conductor holding portion 29, and the coating holding portion 31 are arranged in this order, from the front toward the rear in the front-rear direction.

As described above, the joint terminal 1 is inserted into a hole serving as the accommodating hole 3 formed in the housing 5, and is placed integrally with the housing 5. Namely, within the accommodating hole 3, the lance 33 is provided as illustrated in FIG. 7, and the lance engaging portion 21 is engaged with the lance 33, whereby the joint terminal 1 placed in the housing 5 does not come off from the accommodating hole 3 of the housing 5.

Furthermore, as illustrated in FIG. 1 and the like, a through-hole 39 is formed in a wall portion 37 (a wall portion existing closer to the other end side in the vertical direction than the accommodating hole 3) of the accommodating hole 3, and the lance 33 is formed in the through-hole 39. The base end (rear end) of the lance 33 is connected to a wall (wall on the rear side) of the through-hole 39, and the lance 33 protrudes forward from the wall of the through-hole 39, in a form of cantilever.

As illustrated in FIG. 7, an inclined surface 41 is formed on a portion (portion on the side of the accommodating hole 3; portion located on the side of one end in the vertical direction) inside the lance 33. Furthermore, the top end (front end) of the lance 33 forms a plane 43. Moreover, a part of a portion of the lance 33 on the front side protrudes inside the accommodating hole 3 having a quadrangular prism shape in a normal state (in a state where no external force is applied to the lance 33).

In addition, in a middle state where the joint terminal 1 is placed in the accommodating hole 3 of the housing 5, the top end of the joint terminal 1 is brought into contact with the inclined surface 41 of the lance 33, whereby the lance 33 elastically deforms as illustrated by the arrow in FIG. 7.

After the placement of the joint terminal 1 in the accommodating hole 3 of the housing 5 is completed, the lance 33 is restored as illustrated in FIG. 7, and the plane 43 of the top end of the lance 33 is brought into contact with the lance engaging portion 21, whereby the joint terminal 1 is prevented from coming off from the accommodating hole 3 of the housing 5.

Note that the front end of the joint terminal 1 is brought into contact with a contact portion 45 located at the interior of the accommodating hole 3. With this configuration, the joint terminal 1 is sandwiched by the lance 33 and the contact portion 45, whereby the joint terminal 1 placed in the accommodating hole 3 of the housing 5 does not move in the front-rear direction relative to the housing 5.

Furthermore, the vertical and lateral dimensions of the main body portion 7 of the joint terminal 1 are slightly smaller than those of the accommodating hole 3, whereby the joint terminal 1 placed in the accommodating hole 3 of the housing 5 does not move in the vertical and lateral directions relative to the housing 5.

Incidentally, as described above, the joint terminal 1 is manufactured by forming a sheet-like metal base material into a predetermined shape and subjecting the base material 2 formed into the predetermined shape to bending processing. Then, as can be understood from FIG. 7, a portion of the lance engaging portion 21 of the joint terminal 1, with which the plane 43 of the top end of the lance 33 is brought into contact, is formed by a part of the side surface (a cut surface of the base material 2; a surface perpendicular to both surfaces of the base material 2 in the thickness direction) of the base material 2 formed into the predetermined shape, where the edge 47 is raised.

As illustrated in FIG. 7, the rear wall portion 17 includes a rear wall main body portion 49 and a folded portion 51. The thickness direction of the rear wall main body portion 49 corresponds to the front-rear direction, and the rear wall main body portion 49 is directly connected with the fourth side wall portion 23D of the main body portion 7. The thickness direction of the folded portion 51 corresponds to the vertical direction, and the folded portion 51 is directly connected with the rear wall main body portion 49. Furthermore, the folded portion 51 is located within the cylindrical main body portion 7, and is in contact with the third side wall portion 23C in an overlapping manner.

When the rear wall portion 17 is viewed in the lateral direction, the rear wall main body portion 49 and the folded portion 51 form an L shape.

Furthermore, in the rear wall portion 17, a cutout 53 connecting with the slit 13 of the second side wall portion 23B is formed as illustrated in FIG. 1 and the like. The cutout 53 penetrates the rear wall main body portion 49 in the thickness direction thereof.

The cutout 53 is located at the same position as the slit 13 in the vertical direction, and in the lateral direction, is provided so as to extend from the other end of the rear wall portion 17 to the middle portion of the rear wall portion 17. With this configuration, the cutout 53 is formed so as to be connected with the slit 13. Note that the cutout 53 does not reach one end in the lateral direction.

The width of the cutout 53 is approximately equal to the width (width of the end portion in the front-rear direction) of the slit 13 at the other end in the lateral direction, and gradually becomes narrower toward one end. The width of the cutout 53 at the narrowest portion thereof is approximately equal to the width of the slit 13 at the middle portion in the front-rear direction.

As illustrated, for example, in FIG. 1, the front wall portion 15 includes a front wall main body portion 55 and a folded portion 57. The thickness direction of the front wall main body portion 55 corresponds to the front-rear direction, and the front wall main body portion 55 is directly connected with the fourth side wall portion 23D of the main body portion 7. The thickness direction of the folded portion 57 corresponds to the vertical direction, and the folded portion 57 is directly connected with the front wall main body portion 55. Furthermore, the folded portion 57 is located outside the cylindrical main body portion 7, and is in contact with the third side wall portion 23C in an overlapping manner.

When the front wall portion 15 is viewed in the lateral direction, the front wall main body portion 55 and the folded portion 57 form an L shape.

Moreover, in the same way as at the rear wall portion 17, a cutout 59 connecting with the slit 13 of the second side wall portion 23B is formed also at the front wall portion 15. The cutout 59 penetrates the front wall main body portion 55 in the thickness direction thereof.

As is the case with the cutout 53 of the rear wall portion 17, the cutout 59 is located at the same position as the slit 13 in the vertical direction, and in the lateral direction, is formed so as to extend from the other end to the middle portion. With this configuration, the cutout 59 is provided so as to be connected with the slit 13. Note that the cutout 59 does not reach one end in the lateral direction.

As is the case with the cutout 53 of the rear wall portion 17, the width of the cutout 59 is also approximately equal to the width (width of the end portion in the front-rear direction) of the slit 13 at the other end in the lateral direction, and gradually becomes narrower toward one end. The width of the cutout 59 at the narrowest portion thereof is approximately equal to the width of the slit 13 at the middle portion in the front-rear direction.

Here, the indent 71 will be described in more detail.

The indent 71 is formed so as to have a spherical crown shape. When the plate spring-shaped spring portion 27 is viewed in the thickness direction thereof (vertical direction), the indent 71 is formed so as to have an arch shape whose central angle is larger than 180°.

The arch shape (large arch shape) whose central angle is larger than 180° represents a shape of the larger portion of two portions obtained by drawing a circle on a plane and dividing the circle by one straight line (a line intersecting with the circle but being spaced apart from the center of the circle). Note that a portion of a chord (straight line) of the indent 71, formed into the large arch shape, forms part of an end on the other side of the spring portion 27 in the lateral direction. In addition, by forming the indent 71 into the large arch shape, the peak 73 (the most protruding portion; the center of the circle on which the large arch shape is based) of the indent 71 exists at the spring portion 27, and is slightly spaced apart, from an end on the other side of the spring portion 27 in the lateral direction toward one side (see FIG. 3).

Furthermore, in the joint terminal 1, as illustrated in FIG. 2, the indent 71 protrudes by a height sufficient to avoid interference of the top end of the male contact portion 9 of the other joint terminal 1A with the spring portion 27, even if the spring portion 27 (elastically) deforms due to torsional moment generated in the spring portion 27 at the time when the male contact portion 9 (the male contact portion of the other joint terminal 1A) is engaged with the female contact portion 11 of the joint terminal 1.

Namely, in the joint terminal 1, the protruding height of the indent 71 is higher than the case where the indent 71 is disposed at the center of the spring portion 27. Specifically, a value of the height L4b of the indent 71 illustrated by a solid line in FIG. 4A is greater than the value of the height L4a of an indent illustrated by a long dashed double-short dashed line in FIG. 4A. In addition, even if the spring portion 27 elastically deforms so as to be diagonally tilted due to the torsional moment as illustrated in FIG. 4B, the left end of the male contact portion 9 is not brought into contact with the spring portion 27.

With the joint terminal 1, the indent 71 is formed so as to extend from an end of the spring portion 27 on the other side in the lateral direction to a portion in the vicinity thereof, and thus it is possible to reduce the value of the protruding length of the male contact portion protruding from one end in the lateral direction, as compared with the conventional one.

That is, as illustrated in FIG. 2, when the male contact portion 9 of the second joint terminal 1A (the joint terminal on the right-hand side) is inserted into the main body portion 7 of the first joint terminal 1 (the joint terminal on the left-hand side) and the inserted male contact portion 9 is engaged with the female contact portion 11 of the first joint terminal 1, the indent 71 is located at an end (the end on the right-hand side) of the spring portion 27, and thus the value of the protruding length of the male contact portion 9 can be reduced as compared with the conventional one (the value of the dimension L2 in FIG. 2 can be reduced).

Furthermore, with the joint terminal 1, the indent 71 is formed into the spherical crown shape, and in addition, the indent 71 is formed so as to have an arch shape whose central angle is larger than 180° when the plate spring-shaped spring portion 27 is viewed in the thickness direction thereof. Therefore, the peak 73 of the indent 71 is reliably brought into contact with the male contact portion 9, and the female contact portion 11 and the male contact portion 9 are reliably brought into contact with each other.

Moreover, as described above, in the joint terminal 1, the indent 71 protrudes to a height sufficient to prevent the top end of the male contact portion 9 from interfering with the spring portion 27 even if the spring portion 27 elastically deforms due to the torsional moment generated in the spring portion 27 at the time when the male contact portion 9 is engaged with the female contact portion 11, and thus the indent 71 is reliably brought into contact only with the male contact portion 9.

Namely, since the value of the dimension L4b (the protruding height of the indent 71 of the spring portion 27 of the joint terminal 1 according to the embodiment of the present invention) is greater than the value of the dimension L4a (the protruding height of the indent 305 of the spring portion 307 of the conventional joint terminal 311) illustrated in FIG. 4A, it is possible to prevent the male contact portion 9 and the spring portion 27 from interfering with each other at portions other than the indent 71 even if the spring portion 27 elastically deforms and is twisted as illustrated in FIG. 4B.

Note that the indent 71 is formed into a shape obtained by cutting out a part of a circle, in the descriptions above. However, as illustrated in FIG. 5A and FIG. 5B, it may be possible to form the indent 71 into a shape obtained by cutting out a part of an oval or ellipse.

### INDUSTRIAL APPLICABILITY

According to the present invention, an effect is exerted in which it is possible to provide a joint terminal manufactured by forming a sheet-like metal base material into a predetermined shape and subjecting the base material formed into the predetermined shape to bending processing, the joint terminal being capable of reducing a value of the protruding length of a male contact portion protruding from an end portion on one side in the lateral direction, as compared with the conventional one.

### REFERENCE SIGNS LIST

1 joint terminal

2 base material

7 main body portion

9 male contact portion

11 female contact portion

13 slit

23A first side wall portion

23B second side wall portion

27 spring portion

71 indent

1. A joint terminal manufactured by forming a sheet-like metal base material into a predetermined shape and subjecting the base material formed into the predetermined shape to bending processing, comprising:
a main body portion formed into a rectangular-cylindrical shape;
a male contact portion protruding from a first side wall portion that is a side wall portion on one side of the main body portion in a lateral direction;
a female contact portion which is located inside the main body portion and includes a plate spring-shaped spring portion having an indent formed thereon, in which the indent is formed so as to extend from an end of the spring portion on the other side in the lateral direction to a portion in the vicinity thereof, and in which a portion having the indent formed thereon is raised higher than a surrounding portion at an end of the spring portion on the other side in the lateral direction; and
a slit provided at a second side wall portion that is a side wall portion on the other side of the main body portion in the lateral direction.

2. The joint terminal according to claim 1, wherein
the indent is formed into a spherical crown shape, and a peak of the spherical crown exists at the spring portion.

3. The joint terminal according to claim 1, wherein
the indent protrudes by a height sufficient to avoid interference of a top end of the male contact portion of another joint terminal with the spring portion even if the spring portion deforms due to torsional moment generated in the spring portion at the time when the male contact portion of the another joint terminal is engaged with the female contact portion.

4. The joint terminal according to claim 2, wherein
the indent protrudes by a height sufficient to avoid interference of a top end of the male contact portion of another joint terminal with the spring portion even if the spring portion deforms due to torsional moment generated in the spring portion at the time when the male contact portion of the another joint terminal is engaged with the female contact portion.
